(19) United States
(12) Patent Application Publication
(10) Pub. No.: US 2004/0117450 A1
(43) Pub. Date: Jun. 17, 2004

(54) Gateway email concentrator

(76) Inventors: David T. Campbell, Redmond, WA (US); Sergey Solyanik, Seattle, WA (US)

Correspondence Address: LEE & HAYES PLLC, 421 W RIVERSIDE AVENUE SUITE 500, SPOKANE, WA, 99201

(21) Appl. No.: 10/319,005

(22) Filed: Dec. 13, 2002

(51) Int. Cl. G06F 15/16

(52) U.S. Cl. 709/207

(57) ABSTRACT

An email concentrator implemented as part of a residential gateway device receives email associated with multiple email accounts from multiple email servers, stores the email, and serves the email to multiple email client applications associated with the multiple email accounts. The email concentrator may also perform centralized processing functions associated with the email, such as virus scanning, filtering, or user-defined rule application.

### TECHNICAL FIELD

This invention relates to gateway devices and, in particular, to a gateway email concentrator.

### BACKGROUND

As technology has advanced and email has become a more common method of communication, many computer users have established multiple email accounts. For example, a user may have a corporate email account that is managed by an employer, a second email account that is provided through an internet service provider (ISP), and a third web-based email account. The user may be able to access email through the corporate account while at work or while connected to a corporate network, for example, through a virtual private network (VPN) connection. The user may be able to access email through the ISP provided account from a desktop computer at home that is configured to communicate with the ISP. The user may be able to access the web-based email account from any computer through which an internet connection is available.

Managing multiple email accounts that each may be accessible from limited physical locations can be a frustrating task for a user. Although some email systems allow users to configure an account to receive email that is sent to another account (e.g., an ISP-provided account can be configured to also provide access to email received through a web-based email account), accessibility may still be limited by physical location and email service features such as SPAM filters may not be consistently applied. Also, due to increased network traffic at peak usage times, a user may be unable to connect to the Internet through an ISP account, and thus be unable to download email from accounts that require an Internet connection (e.g., ISP-provided email accounts, web-based email accounts, or corporate accounts accessed through a VPN).

A residential gateway device serves as a centralized access point between a local area network, such as in a small business or home, and a wide area network, such as the Internet. The purpose of a residential gateway is to provide network address translation (NAT) services, which allow one or more client computer systems on a local area network to communicate through one central access point with one or more computer systems on a wide area network, such as the Internet using a single IP address that is associated with the gateway device. For example, using a residential gateway device, multiple computer systems can access the Internet through one internet connection established between the residential gateway device and the Internet. Furthermore, a residential gateway device can be configured to be accessible by other computers connected to the Internet by way of the IP address associated with the residential gateway device. Example residential gateway devices include DSL modems, cable modems, and wired or wireless network routers.

### SUMMARY

A residential gateway device implemented as an email concentrator is described. The email concentrator receives email associated with multiple email accounts from one or more email servers. The received email is stored and optionally processed, for example, by a virus scan application, filtering application, or user-defined rule application. The email concentrator receives requests from and serves the stored email to email client applications.

### BRIEF DESCRIPTION OF THE DRAWINGS

The same numbers are used throughout the drawings to reference like features and components.

FIG. 1 illustrates an exemplary environment in which a gateway email concentrator may be implemented.

FIG. 2 illustrates select components of an exemplary residential gateway device.

FIG. 3 illustrates select components of an exemplary email concentrator implemented as part of a residential gateway device.

FIG. 4 illustrates a method for handling email using an exemplary gateway email concentrator.

### DETAILED DESCRIPTION

The following discussion is directed to a residential gateway device that implements an email concentrator. The email concentrator performs the functions of an email client to receive email from one or more email servers in a wide area network such as the Internet. The email concentrator performs the functions of an email server, serving the received email to one or more client computer systems in a local area network. The email concentrator may also be implemented to download email during off-peak times and perform virus scans, apply filters, and enforce other rules that may be defined by a user.

Exemplary Environment

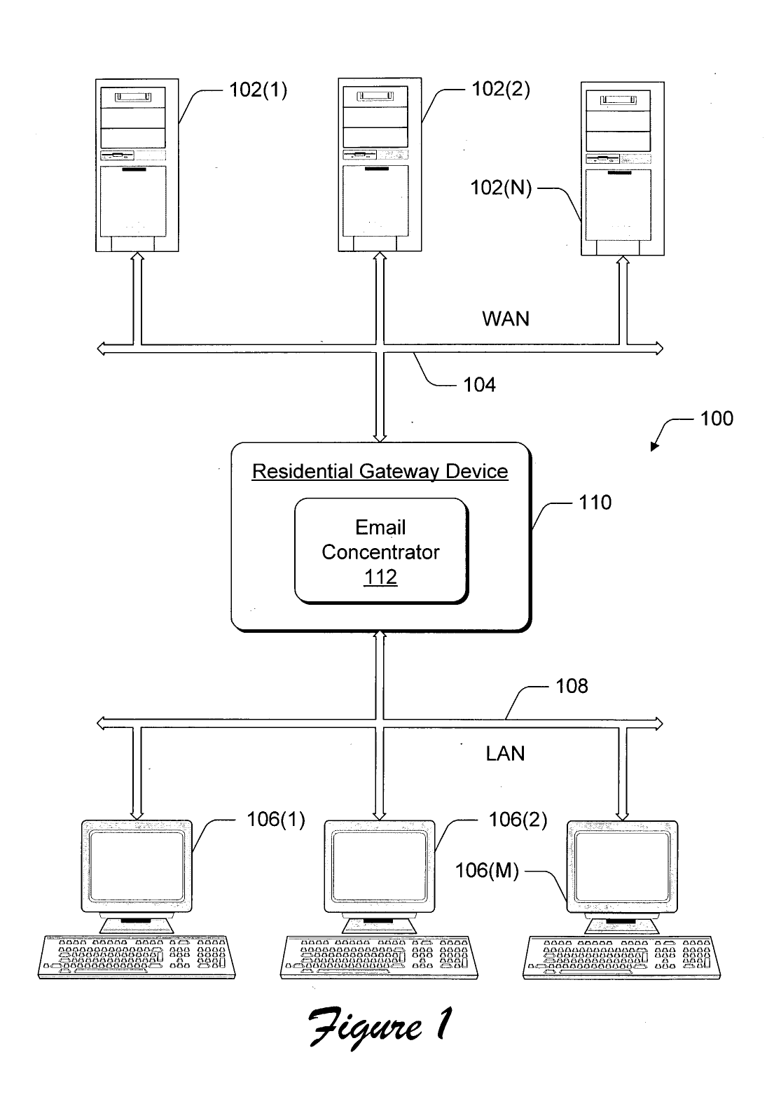

FIG. 1 illustrates an exemplary environment 100 in which a gateway email concentrator may be implemented. The environment 100 includes one or more email servers 102(1), 102(2), . . . , 102(N) connected to a wide area network (WAN) 104, such as the Internet. Environment 100 also includes one or more client computer systems 106(1), 106(2), . . . , 106(M) connected to a local area network (LAN) 108. Client computer systems 106 communicate with email servers 102 through residential gateway device 110.

Residential gateway device 110 includes an email concentrator 112 that communicates as an email client with email servers 102, and communicates as an email server with client computer systems 106. Example residential gateway devices include DSL modems, cable modems, wired or wireless network routers, and any other device that can be configured to serve as a central access point between a LAN and a WAN.

Exemplary Residential Gateway Device

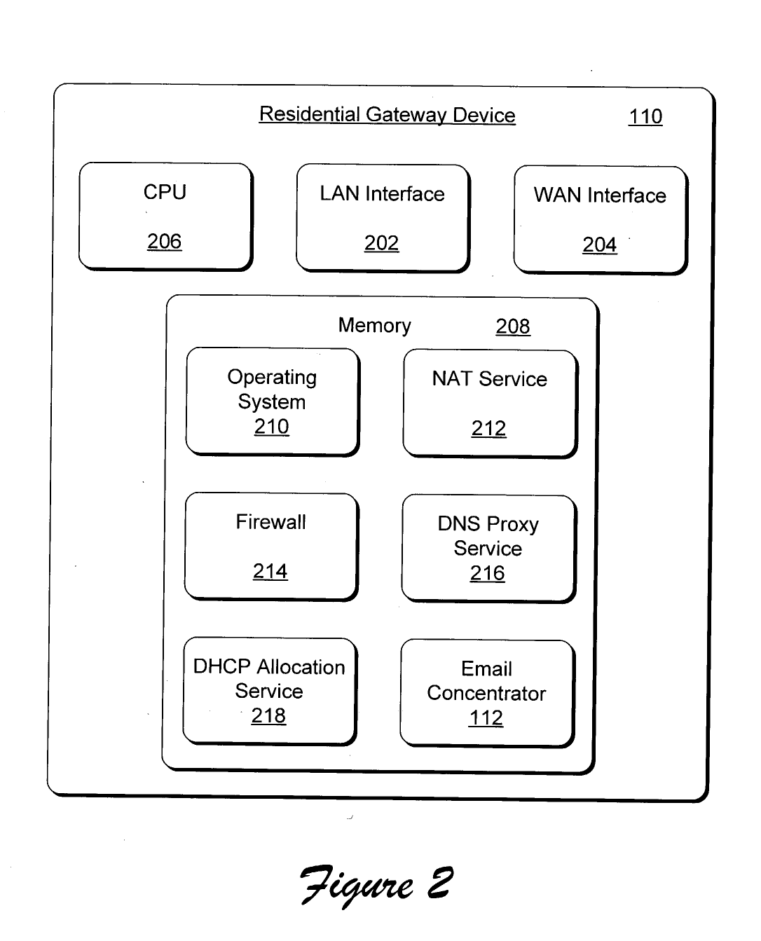

FIG. 2 illustrates select components of an exemplary residential gateway device. Residential gateway device 110 includes local area network (LAN) interface 202 and wide area network (WAN) interface 204. LAN interface 202 facilitates communication between the gateway device 110 and client computer systems 106. A set of one or more Ethernet connections is one example of LAN interface 202, which may be wired or wireless. WAN interface 204 facilitates communication between the gateway device 110 and email servers 102. WAN interface 204 may be implemented as any of a number of interface types. For example, if residential gateway device 110 is implemented as a cable modem, WAN interface 204 may be a cable network connection. Alternately, if residential gateway device 110 is implemented as a DSL modem, WAN interface 204 may be a telephone connection.

Gateway device 110 also includes a central processing unit 206 and memory 208 (e.g., RAM or flash memory). An operating system 210, network address translation (NAT) service 212, and email concentrator 112 are stored in memory 208 and executed on processing unit 206. Gateway device 110 may also optionally include any combination of a firewall 214, a domain name server (DNS) proxy service 216 and a dynamic host configuration protocol (DHCP) allocation service 218, each stored in memory 208 and executed on processor 206.

NAT service 212 allows gateway device 110 to act as an agent between WAN 104 and LAN 108, such that a single IP address, which is associated with the gateway device 110, is used in communications between any client computer system 106 and any email server 102. For example, if client computer system 106(1) sends a request through gateway device 110 to email server 102(1), before forwarding the request to the email server 102(1), gateway device 110 replaces the IP address associated with client computer system 106(1) with an IP address associated with the gateway device 110. Similarly, when gateway device 110 receives a communication from email server 102(1), the gateway device 110 determines which client computer system 106 the communication is directed to and replaces the IP address associated with the gateway device 110 with the IP address associated with the client computer system 106 that the communication is directed to.

Firewall 214 provides an additional level of security between client computer systems 106 and WAN 104. DNS proxy service 216 is used to interpret an Internet address, such as “www.xyz.com”, and convert the internet address to an IP address. DHCP allocation service 218 is used to allocate a dynamic IP address to a client computer system 106 when the client computer system connects to LAN 108.

Email concentrator 112 gathers email from email servers 102, processes and stores the email, and serves the email to client computer systems 106. In an alternate implementation, email concentrator 112 may also be configured to perform centralized processing on outgoing email sent from one or more client computer systems. As an example, such an implementation can provide a mechanism for parents to monitor and/or control their children's email communications. For example, the email concentrator 112 can be configured to generate a log of all email addresses to which outgoing email is sent or to prevent email from being sent from one or more email accounts to one or more email addresses.

Exemplary Email Concentrator

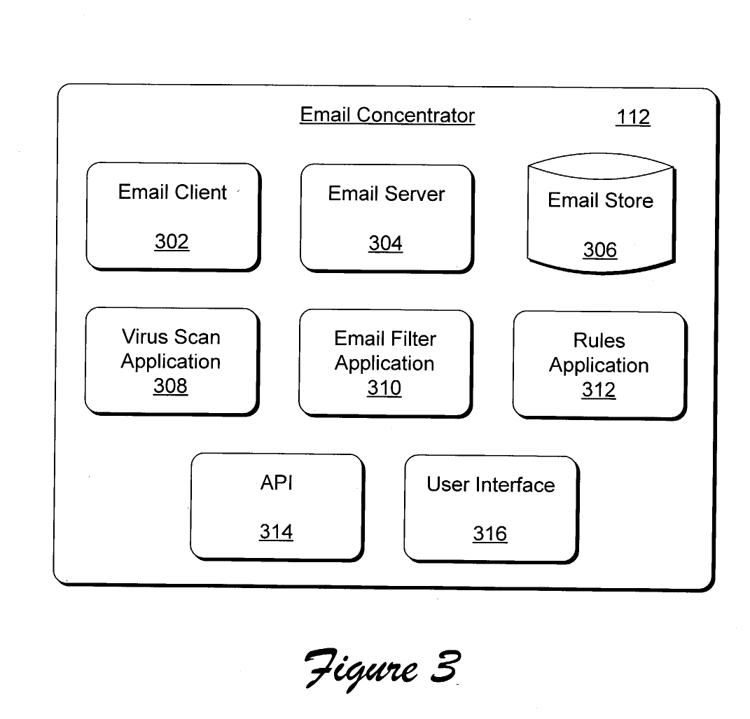

FIG. 3 illustrates select components of email concentrator 112 of residential gateway device 110. Email concentrator 112 includes an email client 302, an email server 304, and an email store 306. Email concentrator 112 may also optionally include any combination of a virus scan application 308, an email filter application 310, rules application 312, an application programming interface (API) 314, and a user interface 316.

Email client 302 is configured to request and receive email from any number of email servers 102 that are accessible via the wide area network 104. Email client 302 can be configured to support any number of email protocols such as POP3 and IMAP. In one implementation, email client 302 is configured to request email from the email servers 102 at regular intervals, which may be configurable by a user or administrator.

When email client 302 receives email from an email server 102, the email is stored in email store 306. Although shown in FIG. 3 as a component of email concentrator 112, email store 306 may be implemented using built in flash memory or a hard disk that is part of residential gateway device 110 or using memory such as a hard disk that is part of a client computer system 106 connected to the LAN 108. In alternate implementations, email store 306 may also be implemented using any other types of memory such as a universal serial bus (USB) removable memory device.

Email server 304 is configured to serve email messages from email store 306 to a requesting email client. Email server 304 may receive requests for email from an email client associated with a client computer system 106 on the LAN 108 or from an email client that accesses the residential gateway device 110 through the WAN 104. Centralizing the location of an email server and an email store as part of a residential gateway device allows users to access their email either from within the LAN or from any system that has access to the WAN.

Email concentrator 112 can optionally include virus scan application 308, email filter application 310, and rules application 312. Virus scan application 308 can be implemented to perform a virus scan on each incoming email message, regardless of the email server it is coming from. Similarly email filter application 310 can be implemented to apply filters to all incoming email messages. Email filtering is well known and can include filters to automatically remove unwanted email messages (commonly known as SPAM). The implementation of a rules application 312 is also well known in other email client applications, and can include user-defined rules for processing messages. For example, messages from a particular email address can be automatically marked with a high priority or forwarded to an alternate email location. Implementing virus scanning, filtering, and application of other rules as part of the email concentrator 112 ensures that these functions are performed consistently with respect to all incoming email messages, regardless of which email server the message is received from. Furthermore, having these functions centralized, simplifies the user task of managing email accounts in that the user can specify custom rules or filters in one place, and those rules and filters can be applied to all incoming messages for multiple email accounts. In an alternate implementation, email concentrator 112 may also be configured to perform virus scanning, filtering, and/or application of user-defined rules on outgoing email sent from a client computer system 106 through the residential gateway device 110.

Email concentrator 112 can also optionally include application programming interface (API) 314. API 314 provides external access to the email store 306. In one implementation, a filter or virus scanning application, implemented either on the residential gateway device 110 or as a service in a client computer system 106, accesses email stored in the email store 306 through API 314.

Email concentrator 112 can also optionally include a user interface 316. User interface 316 can be implemented to provide any number of administrative and/or configuration tools to a user. For example, using the user interface 316, users can define which email accounts on which email servers the email concentrator 112 will pull email from. Furthermore, the user interface 316 may be used by a user to define custom rules or filters and/or to identify, for example, web-based virus scanning services to be used.

Methods for Concentrating Email

Email concentration may be described in the general context of computer-executable instructions, such as application modules, being executed by a computer. Generally, application modules include routines, programs, objects, components, data structures, etc. that perform particular tasks or implement particular abstract data types.

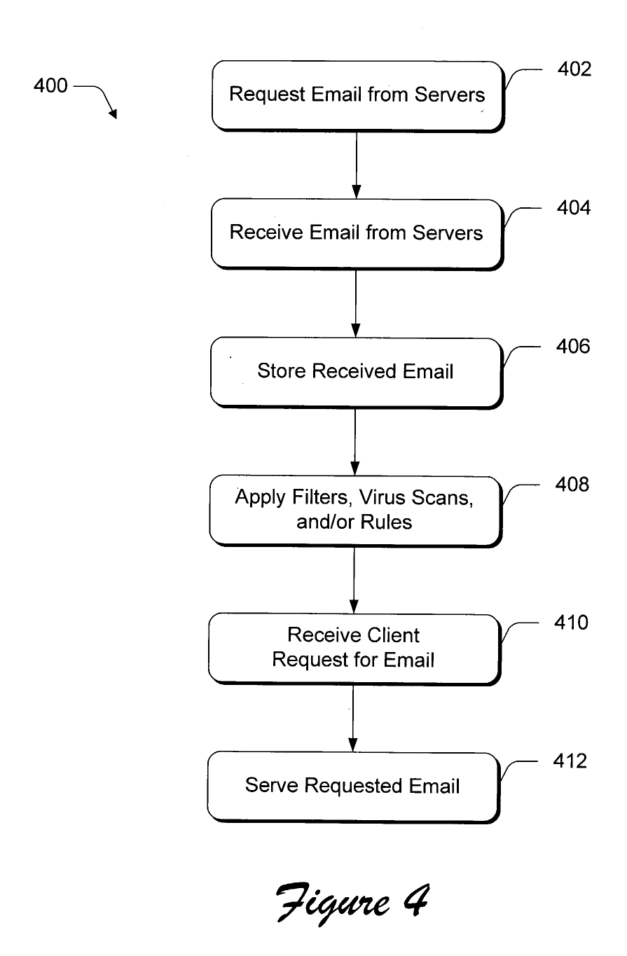

FIG. 4 illustrates a method 400 for gateway concentration of email from multiple email servers for distribution to one or more email clients on one or more client computer systems. The order in which the method is described is not intended to be construed as a limitation. Furthermore, the method can be implemented in any suitable gateway hardware, software, firmware, or combination thereof. For illustrative purposes, method 400 is described below with reference to components illustrated in FIGS. 1 and 3.

At block 402, gateway email concentrator 112 requests email from one or more email servers. Requests for email are made to the multiple email servers 102 by the email client component 302. In one implementation, users configure the gateway email concentrator 112 to request email from multiple email servers for multiple email accounts. The users may also configure an interval at which the email concentrator performs the email requests. According to the configured interval, the email concentrator 112 downloads email from the email servers 102, even if there are no client systems 106 currently requesting email. Accordingly, when a client system 106 does make a request, even if an Internet connection is not available (e.g., due to high Internet traffic through an ISP), the client can still receive email that was previously downloaded by the email concentrator 112. For example, if the email concentrator 112 is configured to download email every 30 minutes, then when a client requests email, even if an Internet connection is unavailable, the client will be able to receive any email received by the email concentrator up until 30 minutes earlier or until the time at which the Internet connection became unavailable. One result of this implementation is that the user will perceive that the Internet connection is more reliable, because from the user's perspective, email is essentially always available.

At block 404, gateway email concentrator 112 receives email from the email servers 102 based on the requests made at block 402.

At block 406, gateway email concentrator 112 stores the received email in email store 306. The email messages are stored according to a pre-defined data structure that identifies a particular email account with which each message is associated.

At block 408, gateway email concentrator 112 performs any defined virus scanning, filtering, and/or other rules. As defined above, this process may include the execution of one or more applications or services stored on the residential gateway device 110, the execution of one or more applications or services stored on a client computer system accessible through LAN 108, or the execution of web-based applications accessible through WAN 104.

At block 410, gateway email concentrator 112 receives a request for email from an email client application. The request may be received from a client application associated with a client computer system 106 that is connected to the residential gateway device 110 through LAN 108, or the request may be received from a client application associate with a system that is connected to the residential gateway device 110 through WAN 108.

At block 412, gateway email concentrator 112 retrieves the requested email from the email store 306 and serves it to the requesting email client.

Conclusion

Although the systems and methods have been described in language specific to structural features and/or methodological steps, it is to be understood that the invention defined in the appended claims is not necessarily limited to the specific features or steps described. Rather, the specific features and steps are disclosed as preferred forms of implementing the claimed invention.

1. A method comprising:
receiving, from an email server, email content associated with an email account;
storing the email content;
receiving a request for email content associated with the email account from a remote client; and
serving the email content that is stored to the remote client.

2. The method as recited in claim 1 wherein the receiving is performed over a connection to a wide area network.

3. The method as recited in claim 1 wherein the receiving is repeatedly performed at a specified time interval.

4. The method as recited in claim 3 wherein the time interval is configurable.

5. The method as recited in claim 1 wherein the serving is performed over a connection to a local area network.

6. The method as recited in claim 1 wherein the serving is performed over a connection to a wide area network.

7. The method as recited in claim 1 further comprising applying a filter to the email content.

8. The method as recited in claim 1 further comprising applying a virus scan to the email content.

9. The method as recited in claim 1 further comprising applying a user-defined rule to the email content.

10. A residential gateway device configured to perform the method as recited in claim 1.

11. A method comprising:
receiving first email content associated with a first email account from a first email server and second email content associated with a second email account from a second email server;
storing the first and second email content;
receiving a request for email content associated with the first email account from a first remote client; and
serving the first email content that is stored to the first remote client.

12. The method as recited in claim 11 further comprising:
receiving a request for email content associated with the second email account from a second remote client; and
serving the second email content that is stored to the second remote client.

13. A method comprising:
receiving first email content associated with a first email account and first email server and second email content associated with a second email account and second email server; and
processing the first and second email content by applying a common process to both the first and second email content.

14. The method as recited in claim 13 wherein the common process comprises a virus scan.

15. The method as recited in claim 13 wherein the common process comprises a filter.

16. The method as recited in claim 13 wherein the common process comprises application of a user-defined rule.

17. A system comprising:
a processor;
a memory; and
an email concentrator to receive, store, and serve email associated with a plurality of email accounts.

18. The system as recited in claim 17 wherein the email concentrator comprises:
an email client component configured to receive email from multiple email servers;
an email store configured to store the email; and
an email server component configured to serve the email to multiple remote clients.

19. The system as recited in claim 18 further comprising:
an application programming interface configured to allow other applications access to the email store.

20. The system as recited in claim 17 further comprising:
a user interface configured to provide tools for a user to manage multiple email accounts.

21. The system as recited in claim 20 wherein the user interface comprises:
account definition tools that allow a user to specify the plurality of email accounts.

22. The system as recited in claim 17, implemented as a residential gateway device.

23. The system as recited in claim 17, implemented as a digital subscriber line modem.

24. The system as recited in claim 17, implemented as a cable modem.

25. The system as recited in claim 17, implemented as a network router.

26. A residential gateway device comprising:
means for receiving email associated with multiple email accounts from multiple email servers;
means for storing the email;
means for serving the email to multiple remote clients.

27. The residential gateway device as recited in claim 26 further comprising means for scanning the email for viruses.

28. The residential gateway device as recited in claim 26 further comprising means for filtering the email.

29. The residential gateway device as recited in claim 26 further comprising means for applying one or more user-defined rules to the email.

30. A residential gateway device implemented as a central access point between multiple client computer systems on a local area network and multiple server computer systems on a wide area network, the residential gateway device comprising:
an email client configured to request and receive email associated with multiple email accounts from one or more of the multiple server computer systems; and
an email server configured to serve the email to one or more of the multiple client computer systems.

31. The residential gateway device as recited in claim 30 further comprising an email store configured to store the email that is received from the multiple server computer systems.

32. The residential gateway device as recited in claim 30, implemented as a digital subscriber line modem.

33. The residential gateway device as recited in claim 30, implemented as a cable modem.

34. The residential gateway device as recited in claim 30, implemented as a network router.

35. One or more computer-readable media comprising computer executable instructions that, when executed, direct a computing system to:
receive email associated with multiple email accounts;
store the email; and
serve the email to multiple remote client applications associated with the multiple email accounts.

36. The one or more computer-readable media as recited in claim 35, further comprising computer executable instructions that, when executed, direct the computing system to:
request the email associated with the multiple email accounts from one or more remote servers according to a configurable time interval.

37. The one or more computer-readable media as recited in claim 35, further comprising computer executable instructions that, when executed, direct the computing system to:
perform a process in association with the email, wherein the process is selected from a group of processes comprising a virus scan, a filter application, and a user-defined rule.
